(19) United States
(12) Patent Application Publication
(10) Pub. No.: US 2015/0146211 A1
(43) Pub. Date: May 28, 2015

(54) OPTICAL COHERENCE TOMOGRAPHY PROBE

(71) Applicant: Corning Incorporated, Corning, NY (US)

(72) Inventors: Venkata Adiseshaiah Bhagavatula, Big Flats, NY (US); Klaus Hartkorn, Painted Post, NY (US); Daniel Max Staloff, Rochester, NY (US)

(21) Appl. No.: 14/541,496

(22) Filed: Nov. 14, 2014

Related U.S. Application Data
(60) Provisional application No. 61/909,771, filed on Nov. 27, 2013.

(51) Int. Cl. G01B 9/02

(52) U.S. Cl. CPC G01B 9/02051; G01B 9/02091
USPC 356/479

(57) ABSTRACT

A monolithic optical coherence tomography (OCT) probe is provided. The probe includes a first section having a groove, an optical fiber in the groove, and a second section having a reflective surface. The optical fiber is in optical communication with the reflective surface.

This application claims the benefit of priority under 35 U.S.C. §119 of U.S. Provisional Application Ser. No. 61/909,771 filed on Nov. 27, 2013, the content of which is relied upon and incorporated herein by reference in its entirety.

### FIELD

The present disclosure relates to a moldable, monolithic optical coherence tomography probe.

### BACKGROUND

Optical coherence tomography (OCT) is used to capture a high-resolution cross-sectional image of scattering biological tissues and is based on fiber-optic interferometry. The core of an OCT system is a Michelson interferometer, wherein a first optical fiber is used as a reference arm and a second optical fiber is used as a sample arm. The sample arm includes the sample to be analyzed as well as a probe that includes optical components. An upstream light source provides imaging light. A photodetector is arranged in the optical path downstream of the sample and reference arms.

Optical interference of light from the sample arm and the reference arm is detected by the photodetector only when the optical path difference between the two arms is within the coherence length of the light from the light source. Depth information from the sample is acquired by axially varying the optical path length of the reference arm and detecting the interference between light from the reference arm and scattered light from the sample arm that originates from within the sample. A three-dimensional image is obtained by transversely scanning in two dimensions the optical path in the sample arm. The axial resolution of the process is determined by the coherence length.

To obtain a suitably high-resolution 3D image, the probe typically needs to meet a number of specific requirements, which can include: single-mode operation at a wavelength that can penetrate to a required depth in the sample; a sufficiently small image spot size; a working distance that allows the light beam from the probe to be focused on and within the sample; a depth of focus sufficient to obtain good images from within the sample; a high signal-to-noise ratio (SNR); and a folded optical path that directs the light in the sample arm to the sample.

In addition, the probe needs to fit within a catheter, which is then snaked through blood vessels, intestinal tracks, esophageal tubes, and like body cavities and channels. Thus, the probe needs to be as small as possible while still providing robust optical performance. Furthermore, the probe operating parameters (spot size, working distance, etc.) will substantially differ depending on the type of sample to be measured and the type of measurement to be made.

Conventional OCT probes consist of a silica spacer, GRIN (gradient index) lens, and a reflecting micro-prism. However, probes using this design are difficult to mass produce because the components have tight tolerances, particularly in regards to deviations in thickness, and there are many assembly steps. In addition, conventional probes rely on refraction from an external surface as the optical element of power, which reduces probe effectiveness in environments other than air, for example, in immersion applications such as cardiac imaging.

### SUMMARY

According to an embodiment of the present disclosure, a monolithic optical coherence tomography (OCT) probe is provided. The probe includes a first section having a groove, an optical fiber in the groove, and a second section having a reflective surface. The optical fiber is in optical communication with the reflective surface.

According to another embodiment of the present disclosure, an optical coherence tomography (OCT) probe is provided. The probe includes a monolithic body having a cavity, the cavity being open at one end of the body and closed at the other end of the body. The probe also includes a ferrule in the cavity, an optical fiber within the ferrule, and at least one optical element in the cavity between the ferrule and the closed end of the body. The optical fiber is in optical communication with the at least one optical element.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 illustrates a monolithic OCT probe in accordance with an embodiment of the present disclosure;

FIG. 2 illustrates passage of light in a monolithic OCT probe in accordance with an embodiment of the present disclosure;

FIG. 3A illustrates a portion of a monolithic OCT probe in accordance with an embodiment of the present disclosure;

FIG. 3B illustrates a portion of a monolithic OCT probe in accordance with an embodiment of the present disclosure;

FIG. 3C illustrates a portion of a monolithic OCT probe in accordance with an embodiment of the present disclosure;

FIG. 4 illustrates a refractive design OCT probe in accordance with an embodiment of the present disclosure;

FIG. 5 illustrates a refractive design OCT probe in accordance with an embodiment of the present disclosure;

FIG. 6 illustrates an OCT probe having a GRIN lens in accordance with an embodiment of the present;

FIG. 7 illustrates an OCT probe in accordance with an embodiment of the present; and

FIG. 8 illustrates a monolithic OCT probe in accordance with an embodiment of the present disclosure.

### DETAILED DESCRIPTION

In one aspect this disclosure is directed to a monolithic, miniature optical probe for optical coherence tomography which includes a simplified assembly having features for fiber alignment. The probe may be made of a plastic material, such as an organic polymer, that is optically transparent over a wide wavelength range. The material is transparent at wavelengths at which the probe is used, which may be, but is not limited to, about 1300 nm. The material may be such that it can be molded into shape while soft and then set into a rigid or slightly elastic form. As used herein, reflective surfaces may be made of dielectric materials or can be metallic.

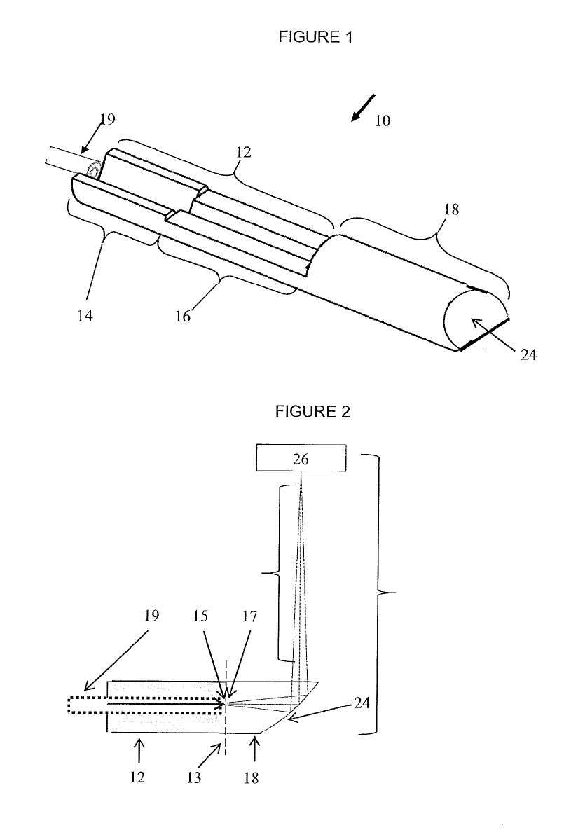

FIG. 1 is a schematic drawing of a monolithic OCT probe 10 having a first section 12 into which an optical fiber 19 is placed, and a second section 18 having a curved reflective surface 24 where light is transmitted out of the probe. Reflective surface 24 may be, for example, a mirror. First section 12 may include a first groove 14 for holding a portion of optical fiber 19 having a polymer coating. First section 12 may also include a second groove 16 for holding a portion of optical fiber 19 free of a polymer coating. First groove 14 may be larger than second groove 16 in order to accommodate the portion of optical fiber 19 having a polymer coating. First groove 14 in conjunction with second groove 16 may provide strain relief to the portions of optical fiber 19 in probe 10.

As shown in FIG. 1, reflective surface 24 is provided within an optically transparent probe 10. As such, changes in material index of probe 10 will not affect the optical power (i.e. focal length) of reflective surface 24. Also, because reflective surface 24 is provided within probe 10, refractive index changes of the external environment do not impact optical power of reflective surface 24.

FIG. 2 illustrates passage of light in a monolithic OCT probe according to embodiments of the present disclosure. Light is passed through optical fiber 19 and into second section 18 where it reflects off reflective surface 24 and exits probe 10 to illuminate an object of interest 26. Light is reflected from object of interest 26 and the resulting image can be viewed.

Probes according to embodiments of the present disclosure may include an interface (indicated by dashed line 13) between an optical fiber face 15 and a probe face 17. As shown in FIG. 2, the optical fiber face 15 may be substantially flat. Alternatively, as shown in FIG. 8, the optical fiber face 15 may be angled. According to embodiments of the present disclosure, the corresponding probe face 17 may be complementary to optical fiber face 15. As shown in FIG. 2, probe face 17 may be substantially flat when optical fiber face 15 is substantially flat, and as shown in FIG. 8, probe face 17 may be angled at a complementary angle when optical fiber face 15 is angled. The use of an angled optical fiber face 15 and complementary probe face 17 eliminates back reflection which adversely affects imaging. The angle may be greater than or less than 45° depending on the refractive index of the material, the divergence angle of the light beam from the optical fiber and the radius of curvature of the reflecting surface.

OCT probes according to the present disclosure may also include a monolithic body having a cavity open at one end and closed at the other end, a ferrule for placement of an optical fiber within the cavity, and at least one optical element in the cavity between the ferrule and the closed end of the monolithic body. In a refractive design OCT probe, the cavity may provide separation of a refractive surface from the external environment which may provide sufficient optical power of the optical element.

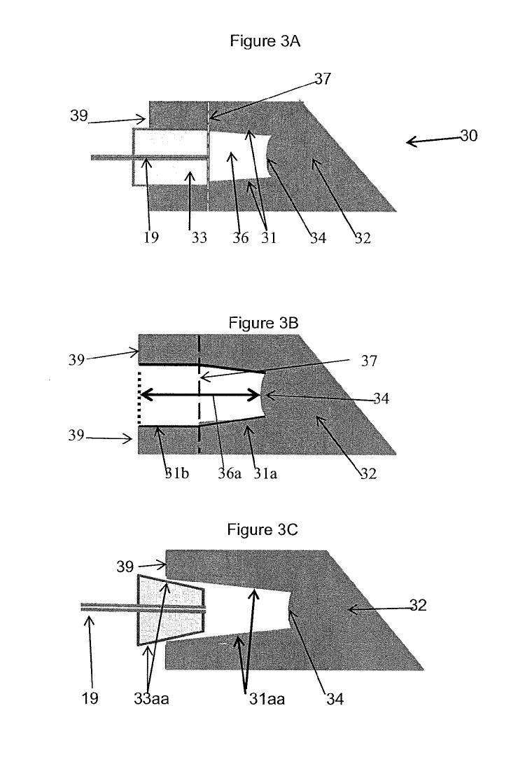

FIG. 3A illustrates a refractive design OCT probe 30 according to an embodiment of the present disclosure. As shown, probe 30 may be molded and may include a body 32 with an integral curved refractive surface 34 and end wall 39. Body 32 may have an interior cavity 36 having interior side walls 31, interior cavity 36 being wider at end wall 39 than at curved surface 34. Dashed line 37 provides a reference for the purposes of describing side walls 31. In the portion of cavity 36 between end wall 39 and dashed line 37, side walls 31 may be parallel to each other. Side walls 31 may be sloped inward toward the interior of body 32 in the portion of cavity 36 between dashed line 37 and curved surface 34. Optical fiber 19, situated within a ferrule 33, may be inserted into cavity 36 to form probe 30. Light passed through optical fiber 19 strikes curved surface 34, is refracted, and exits probe 30.

FIG. 3B illustrates the refractive design OCT probe 30 of FIG. 3A without the ferrule and optical fiber. FIG. 3B illustrates parallel side walls 31b of cavity 36 in the portion of cavity 36 between end wall 39 and dashed line 37, and sloped side walls 31a of cavity 36 in the portion of cavity 36 between dashed line 37 and curved surface 34. The area of cavity 36 is represented by double headed arrow 36a extending from curved surface 34 to a dotted line at the opening of cavity 36 at end wall 39.

As shown in FIG. 3C, cavity 36 may have side walls 31aa that are sloped inward toward the interior of body 32 along the entirety of cavity 36 from end wall 39 to curved surface 34. As shown in FIG. 3C, surfaces of ferrule 33aa may also be sloped to match the slope of side walls 31aa.

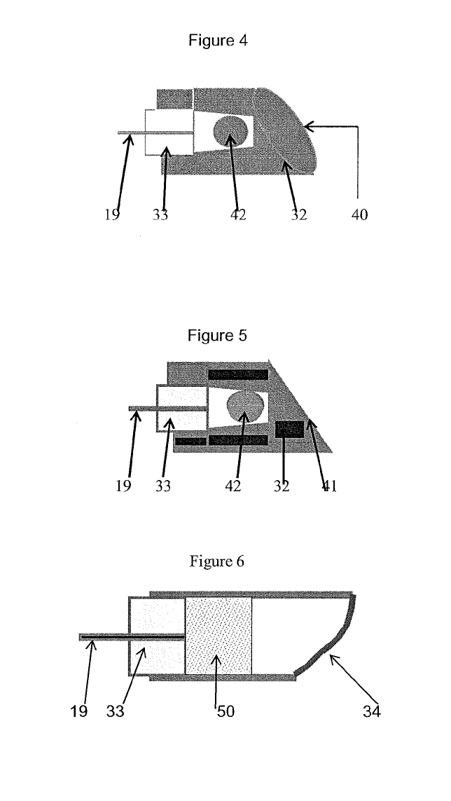

FIGS. 4 and 5 illustrate refractive design OCT probes according to embodiments of the present disclosure. The probe shown in FIG. 4 includes a molded body 32, a total internal reflective surface 40, and a ball lens 42 which acts as a refracting surface. The probe shown in FIG. 5 includes a molded body 32, a reflective surface 41, such as a mirror, and stub lens 42 which acts as a refracting surface. Both of the probes of FIGS. 4 and 5 illustrate optical fiber 19, situated within ferrule 33, may be inserted into a portion of a cavity in body 32.

FIG. 6 illustrates an OCT probe having a GRIN lens according to embodiments of the present disclosure. As shown, the probe includes a reflective surface 34, such as a mirror, and a GRIN lens 50 which acts as a refracting surface. As illustrated, the probe also includes optical fiber 19, situated within ferrule 33, and inserted into a portion of a cavity in probe body.

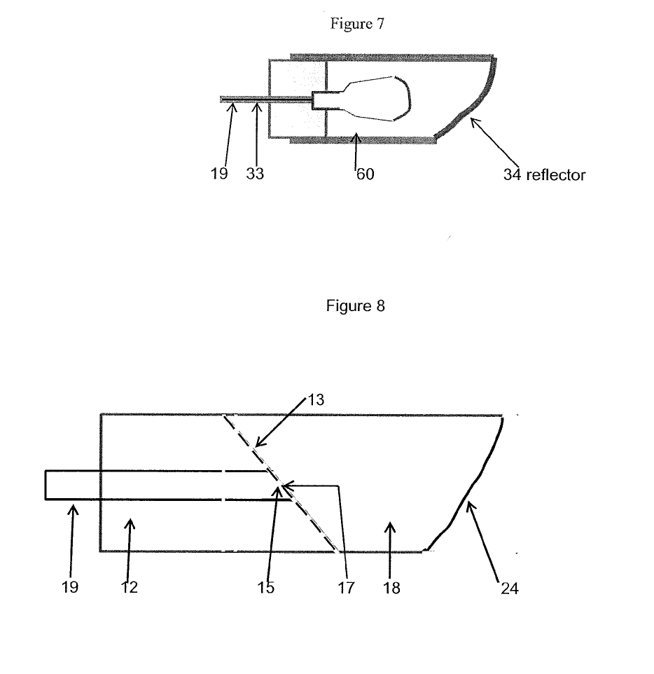

FIG. 7 illustrates an OCT probe having a stub lens according to embodiments of the present disclosure. As shown, the probe includes a reflective surface 34, such as a mirror, and a stub lens 60 which acts as a refracting surface. As illustrated, the probe also includes optical fiber 19, situated within ferrule 33, and inserted into a portion of a cavity in probe body.

In accordance with embodiments of the present disclosure, a monolithic, miniature probe may be formed by a molding process. After the molding is complete, optical fiber may be movably placed into an alignment groove and light may be transmitted through the fiber and into the probe. The resulting spot image may be analyzed using a detector, such as, but not limited to, a camera or a rotating slit, and the optical fiber can be moved into a position where the optical performance is in accord with predetermined specifications. Where the probe includes a groove, the optical fiber can be moved back and forth along the alignment groove axis. The groove facilitates positioning of the optical fiber by limiting movement of the optical fiber other than along the alignment groove axis.

Once the optical fiber has been properly positioned, the optical fiber may be bonded to the probe. An adhesive material may be used to bond the optical fiber to the probe. Examples of adhesive materials may be, but are not limited to, UV curable adhesives and self-curing adhesives such as two part epoxies or thermally curable adhesives.

As described herein, probes according to embodiments of the present disclosure may be monolithic. A monolithic probe reduces the number of optical components, which in turn reduces manufacturing costs. The reduction in probe components also reduces optical back reflections which occur at material interfaces along the optical path of conventional probes. Probes according to embodiments of the present disclosure may also be moldable, which further reduces manufacturing costs.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A monolithic optical coherence tomography (OCT) probe comprising:
a first section having a groove;
an optical fiber in the groove; and
a second section having a reflective surface,
wherein the optical fiber is in optical communication with the reflective surface.

2. The probe of claim 1, wherein the groove comprises first and second groove sections.

3. The probe of claim 2, wherein the optical fiber comprises coat portion and an uncoated portion, and wherein the coated portion is in one of the first and second groove sections, and the uncoated section in in the other of the first and second groove sections.

4. The probe of claim 1, wherein the probe comprises a moldable material.

5. The probe of claim 1, wherein the probe comprises an optically transparent material.

6. The probe of claim 1, further comprising an interface between an optical fiber face and a probe face, wherein the optical fiber face is flat and the probe face is flat.

7. The probe of claim 1, further comprising an interface between an optical fiber face and a probe face, wherein the optical fiber is angled at a first angle and the probe face is angled at a second angle, wherein the first and second angles are complementary angles.

8. An optical coherence tomography (OCT) probe comprising:
a monolithic body having a cavity, the cavity being open at one end of the body and closed at the other end of the body,
a ferrule in the cavity;
an optical fiber within the ferrule; and
at least one optical element in the cavity between the ferrule and the closed end of the body,
wherein the optical fiber is in optical communication with the at least one optical element.

9. The probe of claim 8, wherein a first portion of the cavity comprises parallel side walls, and wherein a second portion of the cavity comprises sloped side walls.

10. The probe of claim 9, wherein the ferrule comprises parallel surfaces that match the slope of the sloped walls of the cavity such that the ferrule fits into the cavity.

11. The probe of claim 8, wherein the cavity comprises sloped side walls.

12. The probe of claim 11, wherein the ferrule comprises sloped surfaces that match the slope of the sloped walls of the cavity such that the ferrule fits into the cavity.

13. The probe of claim 8, comprising two or more optical elements.

14. The probe of claim 13, wherein the two or more optical elements comprise a mirror and a refracting surface.

15. The probe of claim 14, wherein the refracting surface comprises a ball lens.

16. The probe of claim 14, wherein the refracting surface comprises a stub lens.

17. The probe of claim 14, wherein the refracting surface comprises a GRIN lens.
